(19) United States
(12) Patent Application Publication
(10) Pub. No.: US 2023/0408661 A1
(43) Pub. Date: Dec. 21, 2023

(54) METHOD FOR DETERMINING SOILING OF A FIRST ULTRASONIC SENSOR, COMPUTER PROGRAM PRODUCT, COMPUTER-READABLE STORAGE MEDIUM, ULTRASONIC SENSOR APPARATUS, AND ASSISTANCE SYSTEM

(71) Applicant: Valeo Schalter und Sensoren GmbH, Bietigheim-Bissingen (DE)

(72) Inventors: Michael Hallek, Bietigheim-Bissingen (DE); Denis Aschkenasi, Bietigheim-Bissingen (DE)

(73) Assignee: Valeo Schalter und Sensoren GmbH, Bietigheim-Bissingen (DE)

(21) Appl. No.: 18/036,517

(22) PCT Filed: Nov. 9, 2021
(86) PCT No.: PCT/EP2021/081000

§ 371 Date: May 11, 2023

(30) Foreign Application Priority Data
Nov. 11, 2020 (DE) 10 2020 129 666.5

(51) Int. Cl. G01S 7/52; G01S 15/931

(52) U.S. Cl. CPC G01S 7/52004; G01S 15/931; G01S 2007/52009

(57) ABSTRACT

A method for determining soiling of a first ultrasonic sensor of a motor vehicle in which a first ultrasonic signal is emitted by means of the first ultrasonic sensor and the first reflected ultrasonic signal is received by means of the first ultrasonic sensor, and in which a second ultrasonic signal that differs from the first ultrasonic signal is emitted into the environment substantially at the same time as the first ultrasonic signal by a second ultrasonic sensor, wherein the second ultrasonic signal is received by means of the first ultrasonic sensor and the first received ultrasonic signal is compared with the second received ultrasonic signal by an electronic computing device, and the soiling is determined on the basis of the comparison.

The invention relates to a method for determining soiling of a first ultrasonic sensor of an ultrasonic sensor apparatus of an assistance system of a motor vehicle, in which the first ultrasonic sensor is used to transmit a first ultrasonic signal into surroundings of the motor vehicle and the first ultrasonic signal, reflected in the surroundings, is received by means of the first ultrasonic sensor, and in which a second ultrasonic sensor of the ultrasonic sensor apparatus is used to transmit a second ultrasonic signal, which is different than the first ultrasonic signal, into the surroundings essentially simultaneously with the first ultrasonic signal. Furthermore, the invention relates to a computer program product, a computer-readable storage medium, an ultrasonic sensor apparatus and an assistance system.

The prior art already discloses motor vehicles having driver assistance systems. Increasingly high demands are being made on a range of functions, which means that further development of ultrasonic sensors is necessary. In particular, driver assistance systems having ultrasonic sensors are used to support a parking process, so-called parking assistance systems. In this case, the parking assistance system forms part of an at least semi-autonomously operated motor vehicle. In addition to error-free hardware, reliable functioning also requires the detection of, for example, when an ultrasonic sensor is unavailable. A general challenge for ultrasonic sensors relates to the detection of soiling of the sensor system, which reduces detection performance and thus reduces the reliability of the in particular at least semi-autonomously driving motor vehicle. In particular soiling by snow, for example, cannot be detected in most cases. The prior art already discloses approaches such as, for example, an open view test. This involves the ultrasonic sensors being configured for maximum sensitivity, and the possibility of detection during this is used to deduce that the sensor is generally able to detect something and is therefore not soiled by snow. The disadvantage is that no functions are available during this test, since the ultrasonic sensor is being operated outside the normal configuration.

DE 101 21 519 A1 discloses the detection of external matter such as snow or mud adhering to an ultrasonic sensor. An obstacle reflects the transmission of waves from an ultrasonic sensor, and the direct waves are received by an ultrasonic sensor, as a result of which the obstacle is detected. The ultrasonic sensor generates direct waves that are received directly by the ultrasonic sensors, and accordingly the ultrasonic sensors are designed to monitor the direct waves too. The direct waves are attenuated when external matter such as snow or mud adheres to the ultrasonic sensor, and the presence of external matter is detected according to this attenuation.

DE 199 24 755 A1 provides a distance measuring apparatus for measuring the distance from objects on the basis of wave signals that are emitted by the distance measuring apparatus and reflected by the objects, having a transmitting/receiving device for transmitting and receiving wave signals using at least a first and a second transmitting and/or receiving unit, which are spatially spaced apart from one another, of which the first has at least one transmitting function and the second has at least one receiving function. The two units are designed such that the second unit can receive the wave signals emitted by the first unit as crosstalk signals, and either the first unit or the second unit can receive the wave signals emitted by the first unit as reflection signals. The distance measuring apparatus is also provided with an interference determination device for ascertaining at least one characteristic parameter of the crosstalk signals received in the second unit and for determining an interference based on the ascertained characteristic parameter.

DE 10 2011 118 643 A1 relates to a driver assistance device for a motor vehicle, having a first ultrasonic sensor with a membrane for transmitting and receiving ultrasonic waves, wherein the first ultrasonic sensor has a first resonant frequency, and having an ultrasonic sensor with a membrane for transmitting and receiving ultrasonic waves, wherein the second ultrasonic sensor has a second resonant frequency, which is different than the first resonant frequency. A control device actuates the ultrasonic sensors and is designed to switch at least the first ultrasonic sensor between a first operating mode, in which the first ultrasonic sensor transmits the ultrasonic waves at the first resonant frequency, and a second operating mode, in which the first ultrasonic sensor transmits the ultrasonic waves at the second resonant frequency.

The object of the present invention is to provide a method, a computer program product, a computer-readable storage medium, an ultrasonic sensor apparatus and an assistance system that can be used to determine soiling of an ultrasonic sensor in an improved manner.

This object is achieved by a method, a computer program product, a computer-readable storage medium, an ultrasonic sensor apparatus and an assistance system according to the independent patent claims. Advantageous embodiments are specified in the dependent claims.

One aspect of the invention relates to a method for determining soiling of a first ultrasonic sensor of an ultrasonic sensor apparatus of an assistance system of a motor vehicle, in which the first ultrasonic sensor is used to transmit a first ultrasonic signal into surroundings of the motor vehicle and the first ultrasonic signal, reflected in the surroundings, is received by means of the first ultrasonic sensor, and in which a second ultrasonic sensor of the ultrasonic sensor apparatus is used to transmit a second ultrasonic signal, which is different than the first ultrasonic signal, into the surroundings essentially simultaneously with the first ultrasonic signal.

There is provision for the first ultrasonic sensor to be used to receive the second ultrasonic signal reflected in the surroundings, and for the first received ultrasonic signal to be compared with the second received ultrasonic signal by means of an electronic computing device of the ultrasonic sensor apparatus and for the comparison to be taken as a basis for the soiling to be determined by means of the electronic computing device.

Soiling determination can thus be carried out in an improved manner. In the present case, dirt is intended to be understood to mean in particular matter that adheres to the ultrasonic sensor, in the present case in particular a first ultrasonic sensor. In particular, snow, for example, on the first ultrasonic sensor can be regarded as soiling.

The snow prevents the membrane of the ultrasonic sensor from being able to appropriately vibrate, for example. The functionality of the first ultrasonic sensor is therefore at least restricted. In particular, the snow means that the functionality of the first ultrasonic sensor cannot be provided fully. Should the assistance system nevertheless evaluate applicable signals from the first ultrasonic sensor in the event of soiling, this can lead to false detections. It is therefore of crucial importance that the soiling of the first ultrasonic sensor can be reliably detected.

The invention makes use of the fact that expanding the ultrasonic sensors by means of modulated signals means that they are able not only to transmit and receive signals simultaneously but also to distinguish them from one another. At the same time, this parallel operation constitutes the approach to a solution for the open view test without changing the configuration of the ultrasonic sensor and without interrupting the end user function, that is to say for example a parking function. By comparing the two different ultrasonic signals at the same time, this meaning in particular that the first ultrasonic sensor transmits and receives, and the first ultrasonic sensor simultaneously receives the second ultrasonic signal of the neighboring ultrasonic sensor, that is to say the second ultrasonic sensor in the present case. The measurements at the same time always result, under normal conditions, in a different waveform for the two ultrasonic signals. In the case of soiling by snow, for example, the two waveforms are essentially identical, and neither contains any reflection points.

In other words, the method according to the invention uses the possibility of the ultrasonic sensors to transmit encoded, that is to say distinguishable, ultrasonic signals. The ultrasonic sensors are able to extract the two encoded echoes from the received signal, which contains two superimposed encoded echoes, for example. It is now assumed that if the first ultrasonic sensor is blocked, the signal for the two extracted ultrasonic signals essentially contains only the sensor noise. That is to say that if the result is the same for both encodings, there is a blockage. If the results for the encoding differ, there is no soiling.

The two ultrasonic signals are preferably transmitted simultaneously, that is to say at the same time. In the present case, simultaneously is intended to be understood to mean in particular that the first ultrasonic signal and the second ultrasonic signal are transmitted without a time delay. Of course, technical circumstances can mean that minimal time differences occur during transmission, which are ignored in the present case for the explanation of the method according to the invention, however.

According to one advantageous embodiment, the first received ultrasonic signal is taken as a basis for a first reception curve, and the second received ultrasonic signal is taken as a basis for a second reception curve, to be generated by means of the electronic computing device, and the first reception curve is compared with the second reception curve. In particular, the reception curve has reception amplitudes resolved over time. On the basis of reflections, for example from the ground, echoes arise within the reception curve. Comparison of the reception curves can be used to determine whether the first ultrasonic sensor is soiled. In particular, should the two reception curves essentially differ, it can be assumed that there is no soiling. Should the reception curves essentially match, it can be assumed that there is soiling. In particular, the reception curves do not have any echo amplitudes in the event of soiling. This can also be used to identify soiling of the first ultrasonic sensor.

It is also advantageous if no soiling of the first ultrasonic sensor is determined if the first received ultrasonic signal differs from the second received ultrasonic signal. In particular, should the two received ultrasonic signals differ from one another, therefore, it can be assumed that the open space test was positive and there is no soiling of the first ultrasonic sensor. It can thus be concluded that the first ultrasonic sensor has normal functionality.

Furthermore, it has been found to be advantageous if soiling of the first ultrasonic sensor is determined if the first received ultrasonic signal matches the second received ultrasonic signal. In particular, the received signals essentially match. Should the comparison result in it being found that the first ultrasonic signal and the second ultrasonic signal are essentially the same, therefore, it can be concluded that there is soiling of the first ultrasonic sensor. This can then in turn lead to the assistance system being informed of this, so that an evaluation of the ultrasonic signals, for example in the case of a parking function, from this ultrasonic sensor is ignored.

In a further advantageous embodiment, the first ultrasonic signal is transmitted in a different frequency band than the second ultrasonic signal. The transmission on different frequency bands allows different ultrasonic signals to be transmitted. An appropriate extraction in the first ultrasonic sensor can thus be used to reliably differentiate the first ultrasonic signal from the second ultrasonic signal. This allows a reliable comparison of the two ultrasonic signals to be performed.

It is also advantageous if the first ultrasonic signal is transmitted with a different phase modulation than the second ultrasonic signal. The phase modulation results in a phase shift taking place within the transmitted signal. The phase modulation can thus reliably differentiate the first ultrasonic signal from the second ultrasonic signal. This allows reliable determination of the soiling to be carried out.

Furthermore, it has been found to be advantageous if the first ultrasonic signal is transmitted with a different frequency modulation than the second ultrasonic signal. In particular, the first ultrasonic signal thus has a different frequency modulation than the second ultrasonic signal. This allows the first ultrasonic signal to be reliably differentiated from the second ultrasonic signal by means of the first ultrasonic sensor. A reliable comparison and thus reliable determination of the soiling can thus be performed.

According to a further advantageous embodiment, the first ultrasonic signal is transmitted with a frequency modulation for which the frequency increases over time, and the second ultrasonic signal is transmitted with a frequency modulation for which the frequency decreases over time, or the first ultrasonic signal is transmitted with a frequency modulation for which the frequency decreases over time, and the second ultrasonic signal is transmitted with a frequency modulation for which the frequency increases over time. An ultrasonic signal for which the frequency increases over time can also be referred to as a chirp-up. An ultrasonic signal for which the frequency decreases over time can also be referred to as a chirp-down. In particular, for example, the first ultrasonic signal is transmitted as a chirp-up signal, and the second ultrasonic signal is then transmitted as a chirp-down signal. Alternatively, this can also be done inversely. This allows the first ultrasonic sensor to be able to reliably differentiate the first ultrasonic signal from the second ultrasonic signal. A reliable comparison of the two ultrasonic signals can thus be performed. This advantageously allows the determination.

It is also advantageous if a sensor noise of the first ultrasonic sensor is taken into account when determining the soiling. In particular, sensor noise can cause the first ultrasonic signal to differ from the second ultrasonic signal even though there is soiling. This is based in particular on the sensor-internal noise. Taking the sensor-internal noise into account allows the soiling to be determined reliably.

It is also advantageous if a correlation filter of the first ultrasonic sensor can be used to extract the first ultrasonic signal and the second ultrasonic signal from one another. The correlation filter makes it possible for the first ultrasonic signal and the second ultrasonic signal to be reliably extracted. A reliable comparison of the two ultrasonic signals can thus be performed.

In a further advantageous embodiment, the determination of the soiling is carried out before the start of a journey. For example, the open space test can be carried out after the ignition has been started in the motor vehicle. For example, the first ultrasonic signal and the second ultrasonic signal can be transmitted after a user of the motor vehicle has got in and after the ignition has been started. This means that a soiling check can be carried out before a journey actually starts. Alternatively or additionally, it is also possible for the determination of the soiling to be carried out while driving, in particular at predefined intervals of time. There can also be provision for an appropriate soiling check to be carried out for example after the user has pressed a parking button, resulting in the user being able in particular to initiate a parking process.

The method according to the invention is in particular a computer-implemented method.

A further aspect of the invention relates to a computer program product having program code means that are stored in a computer-readable medium in order to carry out the method for determining soiling of a first ultrasonic sensor according to the preceding aspect when the computer program product is executed on a processor of an electronic computing device.

Yet another aspect of the invention relates to a computer-readable storage medium having a computer program product according to the preceding aspect. The computer-readable storage medium can be designed in particular as part of an electronic computing device.

Yet another aspect of the invention relates to an ultrasonic sensor apparatus for a motor vehicle having at least one first ultrasonic sensor, having a second ultrasonic sensor and having an electronic computing device, the ultrasonic sensor apparatus being designed to carry out a method according to the preceding aspect. In particular, the method is carried out by means of the ultrasonic sensor apparatus.

Yet another aspect of the invention relates to an assistance system having an ultrasonic sensor apparatus according to the preceding aspect.

Yet another aspect of the invention relates to a motor vehicle having an assistance system according to the preceding aspect. The motor vehicle is in at least semi-autonomous, in particular fully autonomous, form. Furthermore, the motor vehicle is in particular in the form of a passenger car.

Advantageous configurations of the method are intended to be regarded as advantageous configurations of the computer program product, the computer-readable storage medium, the ultrasonic sensor apparatus, the assistance system and the motor vehicle. For this purpose, the ultrasonic sensor apparatus, the assistance system and the motor vehicle have specific features that allow the method and an advantageous embodiment thereof to be carried out.

Further features of the invention are evident from the claims, the figures and the description of the figures. The features and combinations of features that are cited in the description above and also the features and combinations of features that are cited in the description of the figures below and/or shown in the figures alone can be used not only in the respectively indicated combination but also in other combinations without departing from the scope of the invention. The invention is therefore also intended to be considered to comprise and disclose embodiments that are not explicitly shown and explained in the figures but that result and can be generated from the explained embodiments, by way of separate combinations of features. Embodiments and combinations of features that therefore do not have all the features of an originally formulated independent claim should also be regarded as disclosed. Embodiments and combinations of features that go beyond or differ from the combinations of features set out in the back-references of the claims should furthermore be considered to be disclosed, in particular by the embodiments set out above.

The invention will now be explained in more detail using preferred exemplary embodiments and with reference to the accompanying drawings,

in which:

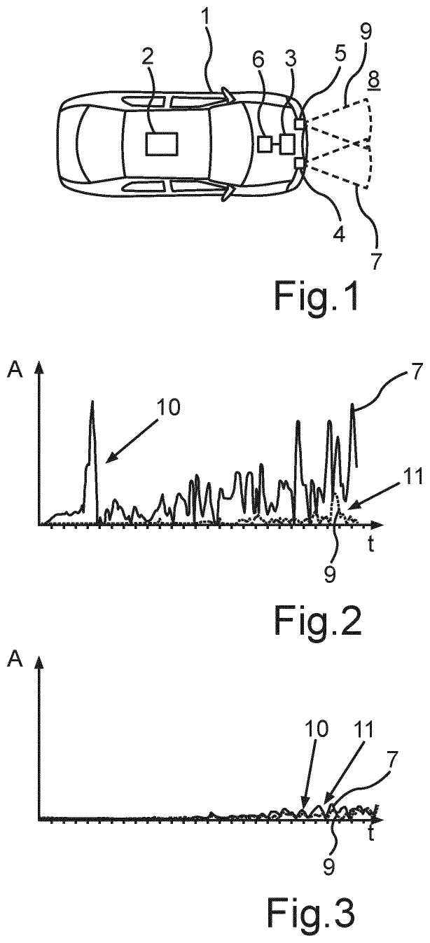

FIG. 1 shows a schematic plan view of an embodiment of a motor vehicle with an embodiment of an assistance system;

FIG. 2 shows a schematic graph of received ultrasonic signals; and

FIG. 3 shows a further schematic graph of received ultrasonic signals.

In the figures, identical or functionally identical elements are provided with the same reference signs.

FIG. 1 shows a schematic plan view of an embodiment of a motor vehicle 1 with an embodiment of an assistance system 2. The assistance system 2 can be embodied as a parking assistance system 2, for example. The motor vehicle 1 can be in at least semi-autonomous, in particular fully autonomous, form. The motor vehicle 1 or the assistance system 2 has an ultrasonic sensor apparatus 3. The ultrasonic sensor apparatus 3 has two ultrasonic sensors 4, 5 in the present exemplary embodiment. It should be mentioned at this point that this is purely illustrative. The ultrasonic sensor apparatus 3 can also have further ultrasonic sensors 4, 5. In the present exemplary embodiment, the ultrasonic sensor apparatus 3 is formed on a front part of the motor vehicle 1. It goes without saying that the ultrasonic sensor apparatus 3 can also be formed, for example, on a rear end and/or on a side of the motor vehicle 1.

In order to be able to carry out the method according to the invention, the ultrasonic sensor apparatus 3 in particular also has an electronic computing device 6. The electronic computing device 6 in turn has, for example, a computer-readable storage medium and a computer program product, which is not shown in the present case.

The method for determining soiling of the first ultrasonic sensor 4 of the ultrasonic sensor apparatus 3 of the assistance system 2 of the motor vehicle 1 involves the first ultrasonic sensor 4 being used to transmit a first ultrasonic signal 7 into surroundings 8 of the motor vehicle 1 and the first ultrasonic signal 7, reflected in the surroundings 8, being received by means of the first ultrasonic sensor 4, and a second ultrasonic sensor 5 being used to transmit a second ultrasonic signal 9, which is different than the first ultrasonic signal 7, into the surroundings 8 essentially simultaneously with the first ultrasonic signal 7.

There is provision for the first ultrasonic sensor 4 to be used to receive the second ultrasonic signal 9 reflected in the surroundings 8, and for the first received ultrasonic signal 7 to be compared with the second received ultrasonic signal 9 by means of the electronic computing device 6 of the ultrasonic sensor apparatus 3 and for the comparison to be taken as a basis for the soiling to be determined by means of the electronic computing device 6.

In particular, there can be provision for the first ultrasonic signal 7 to be transmitted in a different frequency band than the second ultrasonic signal 9. Alternatively or additionally, the first ultrasonic signal 7 can be transmitted with a different phase modulation than the second ultrasonic signal 9. Alternatively or additionally again, the first ultrasonic signal 7 can be transmitted with a different frequency modulation than the second ultrasonic signal 9. There can also be provision for the first ultrasonic signal 7 to be transmitted with a frequency modulation for which the frequency increases over time t (FIG. 2), and for the second ultrasonic signal 9 to be transmitted with a frequency modulation for which the frequency decreases over time t, or for the first ultrasonic signal 7 to be transmitted with a frequency modulation for which the frequency decreases over time t, and for the second ultrasonic signal to be transmitted with a frequency modulation for which the frequency increases over time t. An ultrasonic signal 7, 9 for which the frequency increases over time is referred to in particular as a chirp-up. An ultrasonic signal 7, 9 for which the frequency decreases over time t is referred to in particular as a chirp-down.

Furthermore, there can in particular be provision for the determination of the soiling to be carried out before the start of a journey.

FIG. 2 shows a schematic graph of received different ultrasonic signals 7, 9. In the present case, the ultrasonic signals 7, 9 are shown in particular as reception curves 10, 11. The time t is plotted on the abscissa and the amplitude on the ordinate. In particular, FIG. 2 shows that the reception curves 10, 11 have applicable echoes, this being shown by applicable different amplitudes for the different times t.

In particular, the present case shows that the first received ultrasonic signal 7 is taken as a basis for a first reception curve 10, and the second received ultrasonic signal 9 is taken as a basis for a second reception curve 11, to be generated by means of the electronic computing device 6, and the first reception curve 10 is compared with the second reception curve 11. FIG. 2 shows in particular that the ultrasonic signals 7, 9 or the reception curves 10, 11 differ from one another. In particular, no soiling of the first ultrasonic sensor 4 can then be determined if the first received ultrasonic signal 7 differs from the second received ultrasonic signal 9.

As shown in the present case, the ultrasonic signals 7, 9 can be extracted using a correlation filter. The first ultrasonic signal 7 can thus be reliably distinguished from the second ultrasonic signal 9.

FIG. 2 thus shows in particular so-called envelopes, the first reception curve 10 representing a direct measurement by the first ultrasonic sensor 4 of its own transmitted first ultrasonic signal 7 and the second reception curve 11 representing the indirect measurement of the second ultrasonic signal 9 of the second ultrasonic sensor 5. Due to the different reflections, for example from a ground, the two reception curves 10, 11 differ significantly from one another.

FIG. 3 shows a further schematic graph relating to the received ultrasonic signals 7, 9. FIG. 3 again shows the first reception curve 10 and the second reception curve 11. In the present case, it can be seen in particular that it is essentially possible to record a match between the first reception curve 10 and the second reception curve 11, or the first ultrasonic signal 7 and the second ultrasonic signal 9. In particular soiling of the first ultrasonic sensor 4 can be determined if the first received ultrasonic signal 7 matches the second ultrasonic signal 9. In particular, FIG. 3 shows that the first ultrasonic sensor 4 is not able to detect anything due to the soiling, this being characterized in particular by the fact that the first reception curve 10 and the second reception curve 11 no longer contain any echoes and are essentially the same.

In particular, it can be seen over time t that, in particular at a later reception time, background noise is indicated, which is amplified over distance. In particular, there can now be provision for the sensor noise of the first ultrasonic sensor 4 to be taken into account when determining the soiling.

The proposed method can be used in particular to obtain the soiling within a single measurement cycle. In particular, no additional configuration of the ultrasonic sensor apparatus 3 is necessary. Furthermore, no functions of the ultrasonic sensor apparatus 3, for example the parking function, need to be interrupted. The present case also involves a simple method, for example as a result of comparing a floating average or subtracting the two reception curves 10, 11 or other very simple comparison methods. Furthermore, the method according to the invention is independent of the type of modulation.

In particular, FIGS. 1 to 3 show blindness detection for the first ultrasonic sensor 4 by means of a channel comparison.

1. A method for determining soiling of a first ultrasonic sensor of an ultrasonic sensor apparatus of an assistance system of a motor vehicle, the method comprising:
transmitting, by the first ultrasonic sensor, a first ultrasonic signal into surroundings of the motor vehicle;
receiving the first ultrasonic signal, reflected in the surroundings, by the first ultrasonic sensor,
transmitting, by a second ultrasonic sensor of the ultrasonic sensor apparatus, a second ultrasonic signal, which is different than the first ultrasonic signal, into the surroundings essentially simultaneously with the first ultrasonic signal,
wherein the first ultrasonic sensor is used to receive the second ultrasonic signal reflected in the surroundings, and
comparing the first received ultrasonic signal with the second received ultrasonic signal using an electronic computing device of the ultrasonic sensor apparatus
wherein the comparison is taken as a basis for the soiling to be determined by the electronic computing device.

2. The method as claimed in claim 1, wherein the first received ultrasonic signal is taken as a basis for a first reception curve, and the second received ultrasonic signal is taken as a basis for a second reception curve, to be generated by means of the electronic computing device, and the first reception curve is compared with the second reception curve.

3. The method as claimed in claim 1, wherein no soiling of the first ultrasonic sensor is determined if the first received ultrasonic signal differs from the second received ultrasonic signal.

4. The method as claimed in claim 1, wherein soiling of the first ultrasonic sensor is determined if the first received ultrasonic signal matches the second received ultrasonic signal.

5. The method as claimed in claim 1, wherein the first ultrasonic signal is transmitted in a different frequency band than the second ultrasonic signal.

6. The method as claimed in claim 1, wherein the first ultrasonic signal is transmitted with a different phase modulation than the second ultrasonic signal.

7. The method as claimed in claim 1, wherein the first ultrasonic signal is transmitted with a different frequency modulation than the second ultrasonic signal.

8. The method as claimed in claim 7, wherein the first ultrasonic signal is transmitted with a frequency modulation for which the frequency increases over time (t), and the second ultrasonic signal is transmitted with a frequency modulation for which the frequency decreases over time (t), or the first ultrasonic signal is transmitted with a frequency modulation for which the frequency decreases over time (t), and the second ultrasonic signal is transmitted with a frequency modulation for which the frequency increases over time (t).

9. The method as claimed in claim 1, wherein a sensor noise of the first ultrasonic sensor is taken into account when determining the soiling.

10. The method as claimed in claim 1, wherein a correlation filter of the first ultrasonic sensor is used to extract the first ultrasonic signal and the second ultrasonic signal from one another.

11. The method as claimed in claim 1, wherein the determination of the soiling is carried out before the start of a journey.

12. A computer program product having program code means that are stored in a computer-readable storage medium in order to carry out the method as claimed in claim 1 when the computer program product is executed on a processor of an electronic computing device.

13. A computer-readable storage medium having a computer program product as claimed in claim 12.

14. An ultrasonic sensor apparatus for a motor vehicle, having at least one first ultrasonic sensor, having a second ultrasonic sensor and having an electronic computing device, the ultrasonic sensor apparatus being designed to carry out a method as claimed in claim 1.

15. An assistance system having an ultrasonic sensor apparatus as claimed in claim 14.
